(19) United States
(12) Patent Application Publication
(10) Pub. No.: US 2026/0337970 A1
(43) Pub. Date: Oct. 29, 2026

(54) SHEET FOR STRUCTURE

(71) Applicant: KEIWA Incorporated, Tokyo (JP)

(72) Inventors: Takahiro Tsuji, Chuo-ku, Tokyo (JP); Noriaki OTANI, Chuo-ku, Tokyo (JP); Yuki MATSUNO, Chuo-ku, Tokyo (JP); Kosuke YASUNO, Chuo-ku, Tokyo (JP)

(73) Assignee: KEIWA Incorporated, Tokyo (JP)

(21) Appl. No.: 19/099,193

(22) PCT Filed: Jul. 25, 2023
(86) PCT No.: PCT/JP2023/027227

§ 371 Date: Jan. 28, 2025

(30) Foreign Application Priority Data
Jul. 29, 2022 (JP) 2022-121459
Jul. 24, 2023 (JP) 2023-120111

(51) Int. Cl. E04D 5/10; E04D 5/06; E04G 23/02

(52) U.S. Cl. CPC E04D 5/10; E04D 5/06; E04G 23/02

(57) ABSTRACT

A sheet for a structure 2 has a functional layer 4, an intermediate layer 6, an adhesive layer 8, and a reinforcement 10. A front surface Sf of the sheet 2 is a surface on which the functional layer 4 is exposed. This front surface Sf includes a land 25 and a plurality of recesses 26. These recesses 26 disperse in the land 25, which is the matrix. Between the recess 26 and another recess 26 adjacent to each other, the land 25 is present. The average interval of the recesses 26 is preferably 0.02 mm or more and 1.0 mm or less. The area ratio of the land 25 to the recesses 26 is preferably 20/80 or more and 80/20 or less.

### TECHNICAL FIELD

The present specification discloses a sheet that is used in a state of being pasted to a structure.

### BACKGROUND ART

When exposed to wind and rain for a long period of time, a roof covered with artificial slates deteriorates. There is a concern of a leak in the roof that has deteriorated. For the purpose of preventing the leak in the roof, paint is applied to artificial slates. However, in the case of a roof covered with artificial slates that have significantly deteriorated, the application of paint cannot prevent the leak in the roof in some cases.

WO 2021/010456 discloses a structure protective sheet. This sheet has a polymer cement layer and a resin layer. When this sheet is pasted to a roof, a leak in the roof can be suppressed.

### CITATION LIST

### Patent Literature

[PTL 1] WO 2021/010456

### SUMMARY OF INVENTION

### Technical Problem

For roofs, designability is also important. From the viewpoint of designability, a sheet for a structure having a pattern on the front surface is preferable. A pattern having a three-dimensional shape is preferable. Examples of the pattern having a three-dimensional shape include land-sea patterns. In this land-sea pattern, the matrix is the sea. A plurality of the lands disperse in the matrix. Each land rises from the seas. One example of the land-sea pattern is an embossed pattern.

In repair of a roof, a plurality of sheets are pasted to the roof. The sheets are pasted in a state of being partially overlapped with other sheets. This overlapping generates joints. In the sea at this joint, rainwater can move. Water is capable of passing through the joint along the sea and reaching the surface of the roof. This sheet is not capable of sufficiently preventing a leak in the roof. A sheet having excellent waterproofness is desired.

In repair of roofs that are not covered with artificial slates, sheets are also required to have both designability and waterproofness. In repair or reinforcement of structures other than roofs, sheets are also required to have both designability and waterproofness.

The present applicants intend to provide a sheet for a structure having excellent designability and waterproofness.

### Solution to Problem

A sheet for a structure that is to be disclosed by the present specification has a functional layer and an adhesive layer that is positioned on the back side of this functional layer. The front surface of this sheet for a structure includes a land and a plurality of recesses separated from one another.

### Advantageous Effects of Invention

In this sheet for a structure, the land and the plurality of recesses present on the front surface function as a pattern. This sheet for a structure has excellent designability. Since these recesses are separated from one another, water that has intruded into a certain recess does not reach any adjacent recesses. This sheet also has excellent waterproofness.

### BRIEF DESCRIPTION OF DRAWINGS

FIG. 1 is a perspective view showing a part of a sheet for a structure according to one embodiment.

FIG. 2 is a cross-sectional view taken along a line II-II in FIG. 1.

FIG. 3 is an enlarged view showing a part indicated by a reference signal III in FIG. 2.

FIG. 4 is a cross-sectional view showing the sheet for a structure of FIG. 1 together with a roof.

FIG. 5 is an enlarged view showing a part indicated by a reference signal V in FIG. 4.

FIG. 6 is an enlarged view showing a part indicated by a reference signal VI in FIG. 4.

FIG. 7 is an enlarged perspective view showing a functional layer that is included in the sheet for a structure of FIG. 4.

FIG. 8 is a plan view showing the functional layer of FIG. 7.

FIG. 9 is a cross-sectional view taken along a line IX-IX in FIG. 8.

FIG. 10 is an enlarged plan view showing a part of a reinforcement that is included in the sheet for a structure of FIG. 4.

FIG. 11 is an enlarged view showing a part of a joint of FIG. 6.

FIG. 12 is an enlarged view showing a part of the functional layer of FIG. 9.

FIG. 13 is a cross-sectional view showing a part of a sheet for a structure according to another embodiment.

FIG. 14 is an enlarged photograph showing a front surface of a sheet for a structure according to Example 1.

FIG. 15 is an enlarged photograph showing a front surface of a sheet for a structure according to Example 2.

FIG. 16 is an enlarged photograph showing a front surface of a sheet for a structure according to Comparative Example 1.

### DESCRIPTION OF EMBODIMENTS

Hereinafter, preferable embodiments will be described in detail with appropriate reference to the drawings.

### First Embodiment

### [Layer Structure]

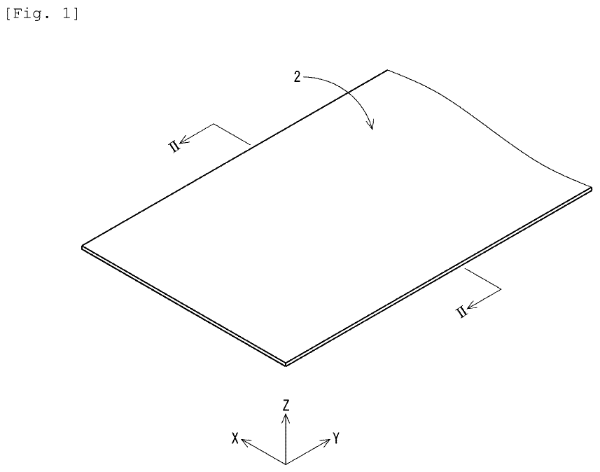

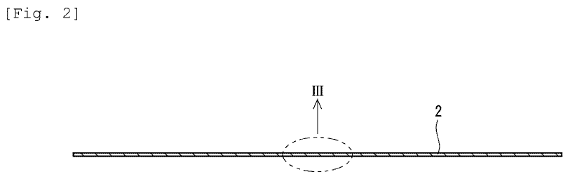

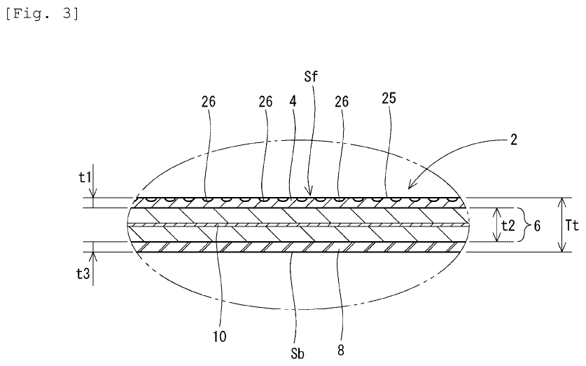

FIGS. 1 to 3 show a sheet for a structure 2. This sheet 2 is pasted to a structure. In FIG. 1, an arrow X indicates the width direction of the sheet 2, an arrow Y indicates the length direction of the sheet 2, and an arrow Z indicates the thickness direction of the sheet 2. The planar shape of this sheet 2 is generally rectangular. As is clear from FIG. 3, this sheet 2 has a functional layer 4, an intermediate layer 6, an adhesive layer 8, and a reinforcement 10. The reinforcement 10 is in a state of being buried in the intermediate layer 6. The material and the like of each layer will be described below in detail. This sheet 2 has a front surface Sf and a back surface Sb. In the present embodiment, a surface on which the functional layer 4 is exposed is the front surface Sf, and a surface on which the adhesive layer 8 is exposed is the back surface Sb. The sheet 2 may have a release paper or a release film. The release paper and the release film are laminated on the adhesive layer 8.

### [Repair of Roof]

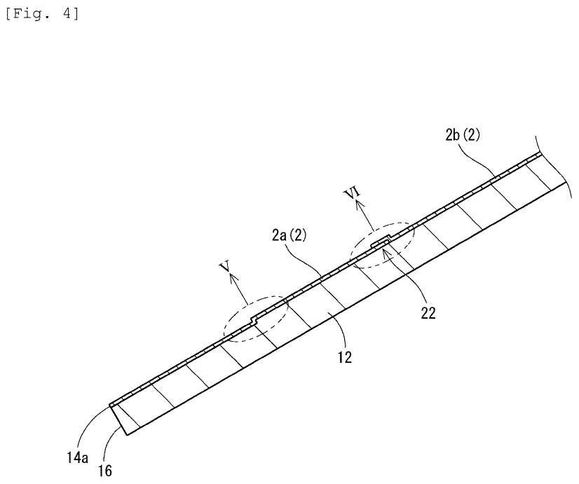

A typical use of this sheet for a structure 2 is the repair of a roof. FIGS. 4 to 6 show a repaired roof 12. In these drawings, two sheets 2 (a first sheet 2a and a second sheet 2b) are shown together with the roof 12. The specification of the second sheet 2b is the same as the specification of the first sheet 2a. Examples of the roof 12 include an artificial slate roof, a tile roof, a steel roof (including a folded-plate roof), a copper roof, a galvanized iron roof, a concrete roof and the like.

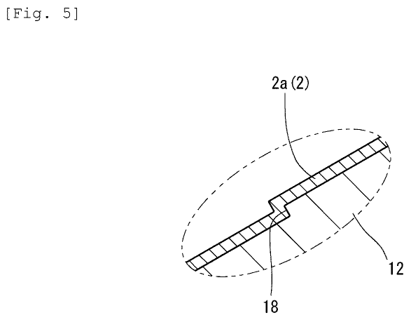

In FIG. 4, the position of a lower edge 14a of the first sheet 2a and the position of a lower edge 16 of the roof 12 coincide in general. The first sheet 2a is pasted to the roof 12 as a whole. As shown in FIG. 5, this roof 12 has a level difference 18. The first sheet 2a curves in the vicinity of this level difference 18. This curve makes the first sheet 2a conform to the level difference 18.

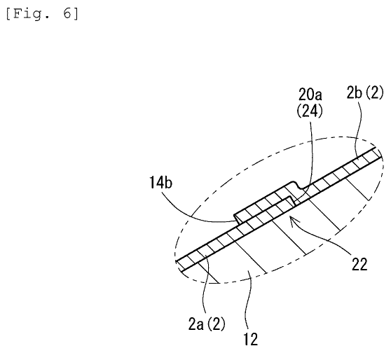

As shown in FIG. 6, the second sheet 2b overlaps the vicinity of an upper edge 20a of the first sheet 2a in the vicinity of a lower edge 14b thereof. This overlapping makes a joint 22 formed. In the second sheet 2b, a portion other than the joint 22 is pasted to the roof 12. An upper edge 20a of the first sheet 2a forms a level difference 24 between this first sheet 2a and the roof 12. The second sheet 2b curves in the vicinity of this level difference 24. This curve makes the second sheet 2b conform to the level difference 24.

### [Primer Layer]

The sheet for a structure 2 is normally pasted to the roof 12 with a primer layer therebetween. In the present specification, a case where the sheet 2 is pasted to the roof 12 with the primer layer or the like therebetween will also be referred to as “the sheet 2 is pasted to the roof 12”. In FIGS. 5 and 6, the primer layer is not shown.

The material of the primer layer is preferably a curable resin composition. As the curable resin, thermosetting resins and photocurable resins are exemplified. A preferable thermosetting resin is an epoxy compound. As the epoxy compound, bisphenol A type epoxy resins, bisphenol F type epoxy resins, bisphenol S type epoxy resins, orthocresol novolac type epoxy resins, alicyclic epoxy resins, aliphatic epoxy resins, diglycidyl ethers of phenols, and diglycidyl ethers of alcohols are exemplified. As a curing agent for the epoxy compound, polyfunctional phenols, amines, polyamines, mercaptans, imidazoles, acid anhydrides and phosphorus-containing compounds are exemplified.

### [Young's Modulus of Sheet]

The Young's modulus of this sheet for a structure 2 is preferably 20 MPa or more and 300 MPa or less. When tension has been applied to the sheet 2 having a Young's modulus of 20 MPa or more, permanent deformation and fracture are less likely to occur. This sheet 2 has excellent handleability. From this viewpoint, the Young's modulus is more preferably 30 MPa or more and particularly preferably 40 MPa or more. The sheet 2 having a Young's modulus of 300 MPa or less has excellent conformability. From this viewpoint, the Young's modulus is preferably 280 MPa or less and particularly preferably 260 MPa or less. The Young's modulus is measured according to the definition of “JIS K 7161”. As a device suitable for the measurement, “Precision Universal Testing Machine AGXTM-V” manufactured by SHIMADZU CORPORATION is exemplified.

### [Moisture Vapor Transmission Rate of Sheet]

The moisture vapor transmission rate of the sheet for a structure 2 is preferably 10 g/m²·day or more. When this sheet 2 has been pasted to a structure, moisture that is contained in the structure or moisture that is present between the structure and the sheet 2 can be discharged through the sheet 2. This sheet 2 is capable of suppressing the corrosion of metal in the structure. This sheet 2 is also suitable for structures containing moisture (for example, a structure having concrete that has not been sufficiently dried). This sheet 2 is also suitable for construction during rainy weather. From these viewpoints, the moisture vapor transmission rate is more preferably 20 g/m²·day or more and particularly preferably 25 g/m²·day or more. The moisture vapor transmission rate is preferably 50 g/m²·day or less. The moisture vapor transmission rate is measured according to the definition of “JIS Z 0208”.

### [Functional Layer]

As is clear from FIG. 3, in the present embodiment, the functional layer 4 is positioned uppermost. In other words, when the sheet 2 has been pasted to a structure, the functional layer 4 is positioned farthest from this structure in the thickness direction Z (refer to FIG. 1). The functional layer 4 contributes to a function desired for the sheet 2. As this function, weather resistance, abrasion resistance, chemical resistance, water impermeability, moisture impermeability and moisture permeability are exemplified. Typical weather resistance is heat resistance and lightfastness. The functional layer 4 is capable of contributing to one or more functions.

A preferable material of the functional layer 4 is a polymer composition. This functional layer 4 is generally flexible. The sheet for a structure 2 having this functional layer 4 is capable of conforming to the unevenness of the base. The polymer composition contains a base material polymer. A synthetic resin, synthetic rubber and natural rubber can be contained in the composition as the base material polymers. The functional layer 4 for which the base material polymer is a synthetic resin is also referred to as “resin layer”.

In a case where lightfastness is desired in the functional layer 4, a base material polymer that is less likely to deteriorate due to ultraviolet rays is preferable. Specifically, polymers having a stronger binding energy than ultraviolet rays (410 KJ/mol) are preferable. As a polymer capable of contributing to the lightfastness of the functional layer 4 and the flexibility of the sheet 2, an acrylic resin, an acrylic urethane resin, an acrylic silicone resin, a fluororesin, a soft epoxy resin and polybutadiene are exemplified.

From the viewpoint of lightfastness, a resin particularly suitable for the base material polymer of the functional layer 4 is an acrylic silicone resin. The acrylic silicone resin has a siloxane bond. The acrylic silicone resin also has excellent heat resistance and cold resistance. Specific examples of a composition containing the acrylic silicone resin include trade name “COOL LIFE SP BLACK (CB1) P5-0” from Dainichiseika Color & Chemicals Mfg. Co., Ltd., trade name “BELL EARTH ELASTIC BLACK” from Fujikura Kasei Co., Ltd., trade name “ARONBULLCOAT T-1000” from Toagosei Co., Ltd. and trade names “ACRYSET EMN325E” and “UWR EF 008” from NIPPON SHOKUBAI CO., LTD.

The polymer composition for the functional layer 4 may contain an additive such as a pigment, a filler, a reinforcing material or an antifouling material as necessary. The functional layer 4 containing a pigment has excellent designability. An organic pigment and an inorganic pigment can be contained in the polymer composition. As the filler, metal oxide particles of silica, alumina, titania and the like are exemplified. As the reinforcing material, a cellulose nanofiber is exemplified. The content rate of each additive is adjusted depending on the function.

In a case where water impermeability and moisture permeability are desired for the functional layer 4, the moisture vapor transmission rate of the functional layer 4 is preferably 10 g/m²·day or more and 50 g/m²·day or less. The moisture vapor transmission rate is measured according to the definition of “JIS Z 0208”.

An arrow t1 in FIG. 3 indicates the thickness of the functional layer 4. From the viewpoint of the function, the thickness t1 is preferably 10 μm or more, more preferably 30 μm or more and particularly preferably 50 μm or more. From the viewpoint of the conformability, productivity and lightweight of the sheet 2, the thickness t1 is preferably 500 μm or less, more preferably 300 μm or less and particularly preferably 150 μm or less. The distribution of the thickness t1 is preferably within a range of 150 μm. The sheet for a structure 2 may have two or more functional layers 4.

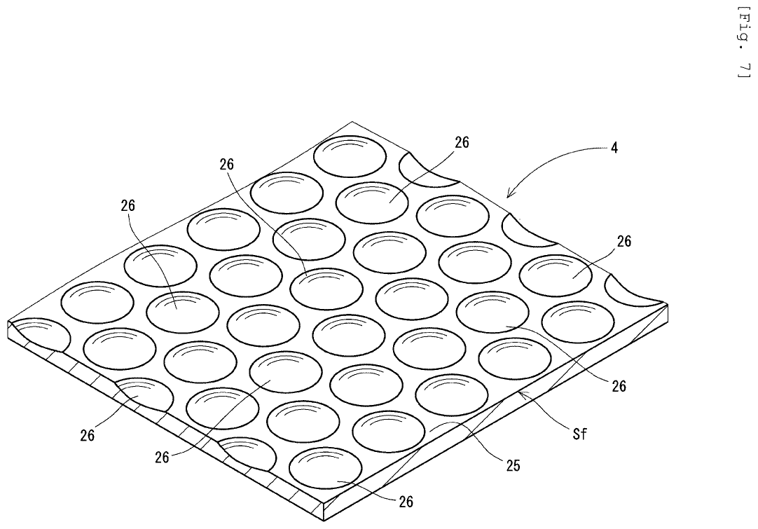

FIGS. 7 to 9 show the functional layer 4 in an enlarged manner. As described above, the front surface Sf of the sheet for a structure 2 is the surface on which the functional layer 4 is exposed. This front surface Sf is made up of a land 25 (protrusion portion) and a plurality of recesses 26 (recess portions). These recesses 26 disperse in the land 25, which is the matrix. In a plan view, the contour shape of each recess 26 is a circle. Between a recess 26 and another recess 26 adjacent thereto, the land 25 is present. The recesses 26 are surrounded by the land 25. In other words, the recesses 26 are separated from other recesses 26. These recesses 26 and the land 25 form a roughness pattern. This sheet for a structure 2 has excellent designability. The sheet 2 may have a recess 26 having a contour shape that is not a circle. As the contour shape that is not a circle, ellipses and polygons are exemplified. As preferable polygons, equilateral triangles, squares, rhombuses, and regular hexagons are exemplified.

### [Intermediate Layer]

(Returning to FIGS. 1 to 3) the intermediate layer 6 contributes to the stiffness or the like of the sheet 2. A preferable material of the intermediate layer 6 is a composite material of a polymer and a filler. As the polymer in the composite material, an acrylic resin, an acrylic silicone resin, a fluororesin, a silicone resin, an epoxy resin, an ethylene-vinyl acetate copolymer and a styrene-butadiene copolymer are exemplified. As the filler in the composite material, cement, silica, alumina, titanium oxide, calcium carbonate and carbon black are exemplified. A preferable composite material is polymer cement. This polymer cement contains a polymer and cement. A typical polymer is an acrylic resin. As the cement, Portland cement, alumina cement and mixtures thereof are exemplified. Portland cement is preferable. The intermediate layer 6 the material of which is polymer cement is also referred to as “polymer cement-cured layer”.

In a case where the intermediate layer 6 contains a polymer and cement, the mass ratio of the polymer in the solid content of the intermediate layer 6 is preferably 10% or more and 40% or less. The intermediate layer 6 in which this ratio is 10% or more has excellent adhesion to other layers (the functional layer 4 or the adhesive layer 8). From this viewpoint, this ratio is more preferably 15% or more and particularly preferably 20% or more. The intermediate layer 6 in which this ratio is 40% or less can contain a sufficient. amount of the cement. From this viewpoint, this ratio is more preferably 35% or less and particularly preferably 30% or less.

In a case where the intermediate layer 6 contains a polymer and cement, the mass ratio of the cement in the solid content of the intermediate layer 6 is preferably 20% or more and 70% or less. In the sheet for a structure 2 having the intermediate layer 6 in which this ratio is 20% or more, a high tensile strength and a small elongation can be achieved. This sheet 2 has excellent handleability. From this viewpoint, this ratio is more preferably 30% or more and particularly preferably 35% or more. The intermediate layer 6 in which this ratio is 70% or less can contain a sufficient amount of the polymer. From this viewpoint, this ratio is more preferably 60% or less and particularly preferably 55% or less.

The intermediate layer 6 can be formed from a liquid mixture obtained from a composition containing a polymer and a composition containing cement. A preferable composition containing a polymer is an acrylic emulsion. This acrylic emulsion can be obtained by the emulsion polymerization of a monomer. The emulsion polymerization can be performed with an emulsifier. The polymerization can be performed in water containing a surfactant. A typical monomer is an acrylic ester or a methacrylic ester. The content of the monomer component in the acrylic emulsion is 20 mass % to 100 mass %.

Specific examples of the composition containing a polymer include trade name “SPRING COAT BRUSH MIXTURE” from KIKUSUI Chemical Industries Co., Ltd. and trade name “ARONBULLCOAT A450 BASE” from Toagosei Co., Ltd. Specific examples of the composition containing cement include trade name “SPRING COAT BRUSH POWDER” from KIKUSUI Chemical Industries Co., Ltd. and trade name “ARONBULLCOAT A450 SETTER” from Toagosei Co., Ltd.

The intermediate layer 6 containing a polymer and cement has excellent moisture vapor transmitting properties. Even when a structure is covered with the sheet 2 having this intermediate layer 6, metal in this structure is less likely to corrode. The moisture vapor transmission rate of the intermediate layer 6 is preferably 20 g/m²·day or more and 60 g/m²·day or less. The moisture vapor transmission rate is measured according to the definition of “JIS Z 0208”.

An arrow t2 in FIG. 3 indicates the thickness of the intermediate layer 6. In the present embodiment, the reinforcement 10 is in a state of being buried in the intermediate layer 6 as described above. Therefore, the thickness t2 is measured, including the reinforcement 10. From the viewpoint of the handleability of the sheet 2, the thickness t2 is preferably 100 μm or more, more preferably 300 μm or more and particularly preferably 500 μm or more. From the viewpoint of the conformability, productivity and lightweight of the sheet 2, the thickness t2 is preferably 1500 μm or less, more preferably 1000 μm or less and particularly preferably 700 μm or less. The distribution of the thickness t2 is preferably within a range of ±100 μm.

The material of the intermediate layer 6 may be a resin composition or a rubber composition. The sheet for a structure 2 may have two or more intermediate layers 6. The sheet for a structure 2 may have two intermediate layers 6 the materials of which are different from each other. The sheet for a structure 2 may have a layer structure in which the intermediate layer 6 is not included.

From the viewpoint of the adhesion of the intermediate layer 6 to the functional layer 4, a base material polymer of the intermediate layer 6 is preferably the same as the base material polymer of the functional layer 4.

### [Adhesive Layer]

The adhesive layer 8 (or bonding adhesive layer) comes into contact with the base. The sheet 2 can be pasted to a. structure with the adhesive force of the adhesive layer 8. The adhesive layer 8 makes it possible to achieve an adhesive force of 0.5 N/mm² or higher between the sheet 2 and the structure.

A preferable material of the adhesive layer 8 is an adhesive composition containing a polymer as the base material. As the polymer suitable for this adhesive composition, an acrylic resin, silicone, polyurethane, polyester, natural rubber and synthetic rubber are exemplified. A polymer particularly preferable as the base material is an acrylic resin. Specific examples of the adhesive composition include trade names “ORIBAIN BPS 6574”, “ORIBAIN BPS 6554” and “ORIBAIN BPS 5565K” from TOYOCHEM CO., LTD.

The adhesive composition may contain a curing agent. In a case where the base material is an acrylic resin, a preferable curing agent is an isocyanate curing agent. The ratio of the isocyanate curing agent relative to 100 parts by mass of the acrylic resin is preferably 1.0 part by mass or more, more preferably 2.0 parts by mass or more and particularly preferably 2.5 parts by mass or more. This ratio is preferably 10 parts by mass or less, more preferably 8 parts by mass or less and particularly preferably 7 parts by mass or less.

The adhesive composition may contain a tackifier. As the tackifier, a rosin-based tackifier, a terpene-based tackifier, a petroleum resin-based tackifier, and a phenolic resin-based tackifier are exemplified. The ratio of the tackifier relative to 100 parts by mass of the base material polymer is preferably 0.5 parts by mass or more, more preferably 1.0 part by mass or more and particularly preferably 1.5 parts by mass or more. This ratio is preferably 15 parts by mass or less, more preferably 10 parts by mass or less and particularly preferably 7 parts by mass or less. Specific examples of the tackifier include trade names “ESTER GUM H”, “ESTER GUM AA-V” and “ESTER GUM 105” from ARAKAWA CHEMICAL INDUSTRIES, LTD.

An arrow t3 in FIG. 3 indicates the thickness of the adhesive layer 8. From the viewpoint of adhesion, the thickness t3 is preferably 20 μm or more, more preferably 40 μm or more and particularly preferably 50 μm or more. From the viewpoint of the productivity, lightweight and handleability of the sheet 2, the thickness t3 is preferably 500 μm or less, more preferably 200 μm or less and particularly preferably 150 pm or less. The amount of the adhesive layer 8 is preferably 20 g/m² or more and 250 g/m² or less. The sheet for a structure 2 may have two or more adhesive layers 8.

### [Reinforcement 10]

The reinforcement 10 is capable of imparting an appropriate Young's modulus to the sheet for a structure 2. The reinforcement 10 is capable of contributing to a large tensile strength of the sheet 2. Furthermore, the reinforcement 10 is capable of contributing to a small elongation of the sheet 2. The sheet 2 including the reinforcement 10 has excellent handleability. As described above, the reinforcement 10 is in a state of being buried in the intermediate layer 6. The reinforcement 10 may be in a state of being buried in the functional layer 4. The reinforcement 10 may be in a state of being buried in the adhesive layer 8. The reinforcement 10 may also be positioned between the functional layer 4 and the intermediate layer 6.

The reinforcement 10 may also be positioned between the intermediate layer 6 and the adhesive layer 8. In the present specification, the reinforcement 10 means an object capable of imparting a large tensile strength to the sheet 2 compared with an imaginary sheet 2 having the same layer structure as the layer structure of the sheet 2 except that this reinforcement 10 is not included.

The tensile strength of this reinforcement 10 is preferably 5.0 MPa or higher. The sheet 2 in which the tensile strength of the reinforcement 10 is 5.0 MPa or higher is less likely to break even when a tensile force is applied thereto. This sheet 2 has excellent handleability. From this viewpoint, the tensile strength is more preferably 5.5 MPa or higher and particularly preferably 6.0 MPa or higher. From the viewpoint of the conformability of the sheet 2, the tensile strength of the reinforcement 10 is preferably 15.0 MPa or lower, more preferably 10.0 MPa or lower and particularly preferably 7.0 MPa or lower.

The elongation at break of this reinforcement 10 is preferably 15.0% or less. The sheet 2 in which the elongation of the reinforcement 10 is 15.0% or less is less likely to deform even when a tensile force is applied thereto. This sheet 2 has excellent handleability. From this viewpoint, the elongation of the reinforcement 10 is more preferably 13.0% or less and particularly preferably 11.0% or less. From the viewpoint of the conformability of the sheet 2, the elongation of the reinforcement 10 is preferably 5.0% or more, more preferably 7.0% or more and particularly preferably 8.5% or more.

The tensile strength and the elongation are measured according to the test methods for normal nonwovens defined in “JIS L 1913:2010”. A test piece for the measurement is cut out from the reinforcement 10 or the original fabric thereof. Five test pieces having the length direction that coincides with the length direction of the reinforcement 10 or the original fabric thereof and five test pieces having the length direction that coincides with the width direction of the reinforcement 10 or the original fabric thereof are used for the measurement. Ten measurement values are averaged, and the tensile strength and the elongation are calculated.

The ratio of the area of the contour of the reinforcement 10 to the area of the sheet for a structure 2 in a plan view is preferably 60% or more. The reinforcement 10 in which this ratio is 60% or more is capable of contributing to the handleability of the sheet 2. From this viewpoint, this ratio is more preferably 70% or more and particularly preferably 75% or more. This ratio may be 100%. From the viewpoint of the conformability at the joint 22, this ratio is preferably 95% or less.

### [Fabric]

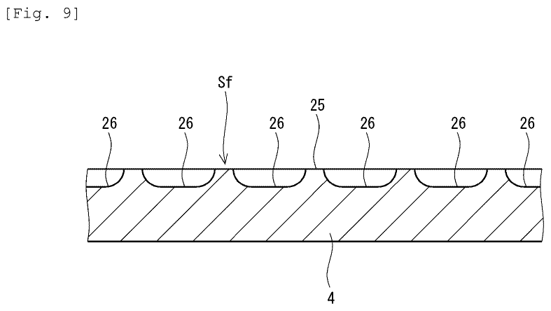

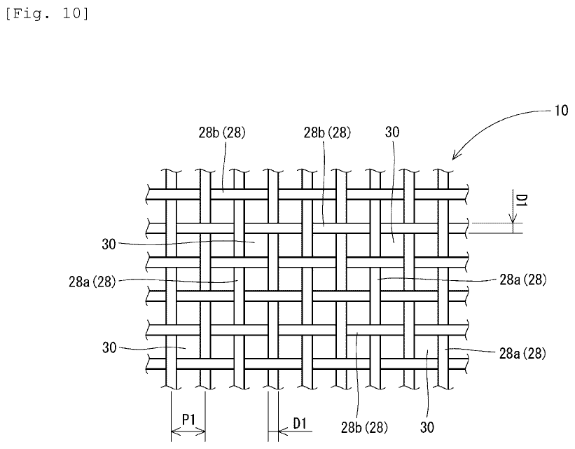

FIG. 10 shows the reinforcement 10. In this reinforcement 10, a plurality of warp threads 28a and a plurality of weft threads 28b are woven. In other words, the reinforcement 10 is a woven fabric (cloth). In the present embodiment, this woven fabric has a plane weave structure. The woven fabric is a kind of fabric. The reinforcement 10, which is a fabric, can be impregnated with the composition of the intermediate layer 6. This impregnation is capable of contributing to the large tensile strength of the sheet 2. This impregnation is further capable of contributing to the small elongation of the sheet 2. The reinforcement 10 may be a fabric other than woven fabrics. As the fabric other than woven fabrics, a knitted item (knit) and a cross-point welded mesh fabric are exemplified.

As the material of the reinforcement 10, a synthetic resin composition and a metal 1 are exemplified. As a preferable base material resin for the synthetic resin composition, polyethylene terephthalate, polyethylene naphthalate, aramid, vinylon, polypropylene, polystyrene and polyvinylidene fluoride are exemplified. As a preferable metal, an aluminum alloy, a carbon steel and an alloy steel are exemplified. Employment of the warp threads 28a and the weft threads 28b having a high tensile strength makes it possible for a sufficiently high tensile strength of the sheet 2 to be achieved. Employment of the warp threads 28a and the weft threads 28b having a small elongation makes it possible for a sufficiently small elongation of the sheet 2 to be achieved.

As is clear from FIG. 10, this reinforcement 10 has a large number of meshes 30. In the present embodiment, the planar shape of each mesh 30 is generally a square. The intermediate layer 6 penetrates these meshes 30. This penetration is capable of contributing to the high tensile strength of the sheet 2. This penetration is further capable of contributing to the small elongation of the sheet 2.

An arrow P1 in FIG. 10 indicates a pitch of the threads 28. The pitch P1 is preferably 1.0 mm or more and 50 mm or less. In the reinforcement 10 in which the pitch P1 is 1.0 mm or more, a lot of the polymer cement or the like penetrates the meshes 30. This reinforcement 10 is capable of contributing to the high tensile strength and small elongation of the sheet 2. From this viewpoint, the pitch Pl is more preferably 1.2 mm or more and particularly preferably 1.5 mm or more. In the reinforcement 10 in which the pitch P1 is 50 mm or less, this reinforcement 10 is capable of contributing to the high tensile strength and small elongation of the sheet 2. From this viewpoint, the pitch P1 is more preferably 40 mm or less and particularly preferably 35 mm or less.

An arrow D1 in FIG. 7 indicates the thickness of the thread 28. The threads 28 having a large thickness D1 make it possible for the high tensile strength and small elongation of the sheet 2 to be achieved. From this viewpoint, the thickness D1 is preferably 0.05 mm or more, more preferably 0.10 mm or more and particularly preferably 0.15 mm or more. The thickness is preferably 1.0 mm or less.

The reinforcement 10 that is not a fabric may be included in the sheet for a structure 2. As the reinforcement 10 that is not a fabric, nonwoven fabrics, long fibers, resin films and metal foils are exemplified. A large number of short fibers dispersed in a composition may be the reinforcement 10. The sheet 2 may also have a layer structure in which the reinforcement 10 is not included.

### [Additional Layer]

The sheet for a structure 2 may have an additional layer that is positioned on the functional layer 4. A typical additional layer is a clear paint layer. The sheet for a structure 2 may have a layer that is positioned between the functional layer 4 and the intermediate layer 6. The sheet for a structure 2 may have a layer that is positioned between the intermediate layer 6 and the adhesive layer 8.

### [Total Thickness]

An arrow Tt in FIG. 3 indicates the total thickness of the sheet 2. The total thickness It is preferably 200 μm or more, more preferably 400 μm or more and particularly preferably 500 μm or more. This total thickness Tt is preferably 5.0 mm or less, more preferably 3.0 mm or less and particularly preferably 1.0 mm or less. The distribution of the total thickness It is preferably within a range of ±100 μm.

### [Waterproofness of Joint]

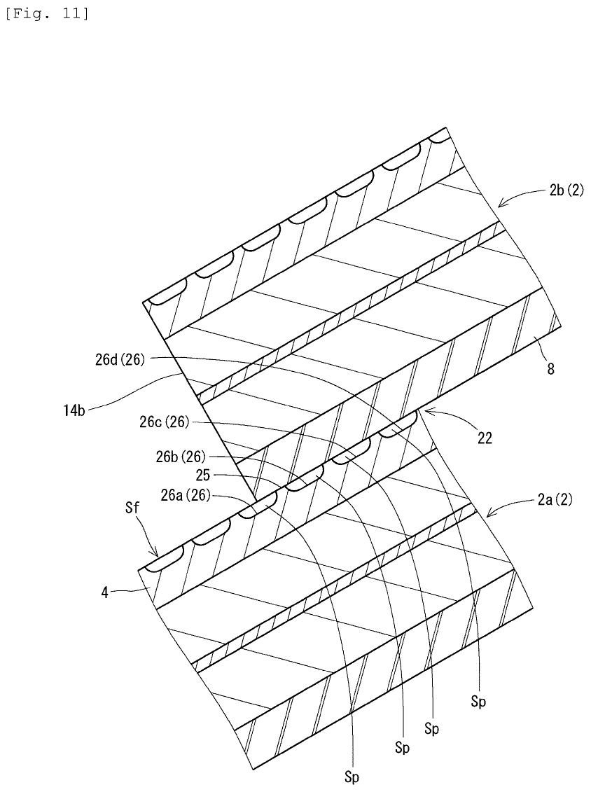

FIG. 11 shows the joint 22 of FIG. 6 in an enlarged manner. In this joint 22, the vicinity of the lower edge 14b of the second sheet 2b covers the front surface Sf of the first sheet 2a. At the time of repair of the roof 12, the composition of the adhesive layer 8 in the second sheet 2b may enter the recesses 26 of the first sheet 2a. This entry accompanies the discharge of the air in the recesses 26.
However, in some of the recesses 26, the entry of the composition is not sufficient, and the air remains. FIG. 11 shows a first recess 26a, a second recess 26b, a third recess 26c and a fourth recess 26d where the air remains. These recesses 26 are separated from one another. A space Sp is generated between each of these recesses 26 and the adhesive layer 8 of the second sheet 2b. In this joint 22, a plurality of the spaces Sp are present. These spaces Sp are separated from one another. The land 25 of the first sheet 2a closely adheres to the adhesive layer 8.

After the repair, water may intrude into the first recess 26a due to an environmental reason such as rainfall. Water accumulates in the first recess 26a. The second recess 26b is separated from the first recess 26a. Therefore, the water in the first recess 26a does not proceed to the second recess 26b.

The third recess 26c is separated from the second recess 26b. Even if water accumulates in the second recess 26b for any reason, this water does not proceed to the third recess 26c.

The fourth recess 26d is separated from the third recess 26c. Even if water accumulates in the third recess 26c for any reason, this water does not proceed to the fourth recess 26d.

In the repaired roof 12, water is less likely to pass through the joint 22. Therefore, water is less likely to reach the roof 12. This sheet for a structure 2 has excellent waterproofness.

### [Specification of Recess]

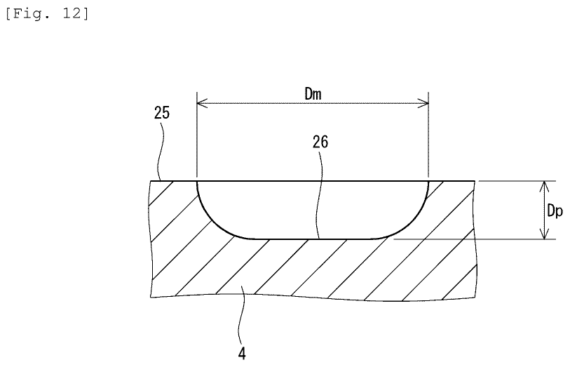

An arrow Dm in FIG. 12 indicates the diameter of the recess 26. The diameters Dm are measured from 100 randomly extracted recesses 26, and the average diameter is calculated. The average diameter is preferably 0.05 mm more and 1.0 mm or less. The recesses 26 having an average diameter of 0.05 mm or more are capable of contributing to the designability of the sheet 2. From this viewpoint, the average diameter is more preferably 0.10 mm or more and particularly preferably 0.15 mm or more. The recesses 26 having an average diameter of 1.0 mm or less are capable of contributing to the designability of the sheet 2. Furthermore, these recesses 26 are less likely to impair the waterproofness. From this viewpoint, the average diameter is more preferably 0.6 mm or less and particularly preferably 0.45 mm or less. In a case where the contour of the recess 26 is not circular, a circle having the same area as the area of this contour is assumed. The diameter of this circle is regarded as the diameter Dm of this recess 26.

An arrow Dp in FIG. 12 indicates the depth of the recess 26. The depths Dp are measured from 100 randomly extracted recesses 26, and the average depth is calculated. The average depth is preferably 0.005 mm or more and 0.50 mm or less. The recesses 26 having an average depth of 0.005 mm or more are capable of contributing to the designability of the sheet 2.

From this viewpoint, the average depth is more preferably 0.020 mm more and particularly preferably 0.030 mm or more The recesses 26 having an average depth of 0.50 mm or less are less likely to impair the waterproofness. Furthermore, these recesses 26 do not impair the durability and weather resistance of the sheet 2. From this viewpoint, the average depth is more preferably 0.08 mm or less and particularly preferably 0.06 mm or less. From the viewpoint of the durability and weather resistance of the sheet 2, the ratio of the average depth to the thickness t1 (refer to FIG. 3) of the functional layer 4 is preferably 80% or less, more preferably 60% or less and particularly preferably 35% or less.

The average area of the recesses 26 is preferably 0.002 mm² or more and 3.0 mm² or less. The recesses 26 having an average area of 0.002 mm² or more are capable of contributing to the designability of the sheet 2. From this viewpoint, the average area is more preferably 0.004 mm² or more and particularly preferably 0.008 mm² or more. The recesses 26 having an average area of 3.0 mm² or less are capable of contributing to the designability of the sheet 2. Furthermore, these recesses 26 are less likely to impair the waterproofness. From this viewpoint, the average area is more preferably 2.5 mm² or less and particularly preferably 1.5 mm² or less. The areas are measured from 100 randomly extracted recesses 26, and the average area is calculated.

The area ratio of the land 25 to the recesses 26 is preferably 20/80 or more and 80/20 or less. The sheet for a structure 2 having this area ratio of 20/80 or more has excellent designability. This sheet 2 further has excellent waterproofness. From these viewpoints, this area ratio is more preferably 30/70 or more and particularly preferably 40/60 or more. The sheet for a structure 2 having this area ratio of 80/20 or less has excellent designability. From these viewpoints, this area ratio is more preferably 75/25 or less and particularly preferably 70/30 or less.

### [Method for Manufacturing Sheet]

Hereinafter, one example of a method for manufacturing this sheet for a structure 2 will be described. In this manufacturing method, the polymer composition for the functional layer 4 is mixed with a solvent, and a first paint is obtained. This first paint is applied onto a base film, and a first coated film is obtained. This first coated film is heated, and the solvent is volatilized from the first paint. The base material polymer is cured by this heating, and the functional layer 4 is obtained. The functional layer 4 having a roughness pattern can be obtained by applying the first paint to a base film having a roughness pattern on the surface. The roughness pattern of the functional layer 4 has a shape in which the shape of the roughness pattern of the base film is reversed.

Subsequently, the composite material for the intermediate layer 6 is mixed with a solvent, and a second paint is obtained. This second paint is applied onto the functional layer 4, and a second coated film is obtained. The reinforcement 10 is pressed against this second coated film. This second coated film is heated, and the solvent is volatilized from the second paint. The polymer is cured by this heating, and the intermediate layer 6 including the reinforcement 10 is obtained.

Subsequently, the adhesive composition for the adhesive layer 8 is mixed with a solvent, and a third paint is obtained. This third paint is applied onto a release film, and a third coated film is obtained. This third coated film is heated, the solvent is volatilized from the third paint, and the adhesive layer 8 is obtained.

This adhesive layer 8 is overlapped with the intermediate layer 6. Furthermore, the base film is peeled off from the functional layer 4, the release film is peeled off from the adhesive layer 8, and the sheet for a structure 2 is obtained. The release film may remain in the sheet for a structure 2.

### [Uses]

This sheet for a structure 2 has excellent conformability and can be thus applied to the roof 12 in which the level difference 18 is present as described above. When a plurality of the sheets 2 are patched and pasted, the surface of the roof 12 can be covered with the sheets 2 in a wide area. Since the sheet 2 has the adhesive layer 8, it is not essential to apply an adhesive (or a bonding adhesive) to the roof 12. Since this adhesive layer 8 has excellent adhesion, the surface of the roof 12 can be covered with the sheets 2 in a wide area even in a case where the materials of the surface of the roof 12 are composite. For example, even in the roof 12 including both a metal and artificial slates on the surface, the surface of the roof 12 can be covered with the sheets 2 in a wide area.

The entire surface of the roof 12 may be covered with the sheets 2. In the present specification, the surface of the roof 12 means a surface that can be visually recognized when the roof 12 is seen from above in the vertical direction. A repair method in which the entire surface of the roof 12 is covered with the sheets 2 of a single kind cannot be found from conventional construction methods.

This sheet 2 is lightweight compared with a steel plate, a copper plate, a galvanized plate or the like. Therefore, even when the surface of the roof 12 is covered with the sheets 2 in a wide area, there is only a small adverse effect on the earthquake resistance of buildings. From the viewpoint of earthquake resistance, the density of the sheet 2 is preferably 4.0 g/cm³ or less, more preferably 3.0 g/cm³ or less and particularly preferably 2.5 g/cm³ or less. This density is significantly low compared with the density of an aluminum-zinc alloy plated steel plate (trade name “Galvalume steel plate”) that is frequently used for the repair of the roof 12.

### [Other Uses]

This sheet 2 is also capable of contributing to the repair or reinforcement of structures other than the roof 12. Examples of the structures other than the roof 12 include walls, pillars, eaves, fences, gates, doors, parapets, copings and the like of houses. This sheet 2 may also be used in commercial buildings, factories, warehouses, bridges, sewage facilities, railway facilities, utility poles, tunnels and the like.

### [Re-Repair and Re-Reinforcement]

After a structure (the roof 12 or the like) is repaired or reinforced with this sheet 2 or a different sheet, there are cases where the sheet or the structure breaks or deteriorates due to aging. Re-repair or re-reinforcement can be performed by pasting a newly-prepared sheet for a structure 2 to the sheet in this breakage place or deterioration place. When the new sheet 2 is pasted to the old sheet, the value of the structure can be preserved and maintained for an extremely long period of time. This pasting (overlapping) can be achieved with the adhesive force of the adhesive layer 8 in the new sheet 2. In this re-repair or re-reinforcement, there is no need to dispose of the old sheet. In this re-repair or re-reinforcement, waste generation can be suppressed. This sheet 2 conforms with the gist of the circular economy. Even when the sheet 2 having a low density is laminated on the old sheet, there is only a small adverse effect on the earthquake resistance of the structure.

### Embodiment 2

### [Layer Structure]

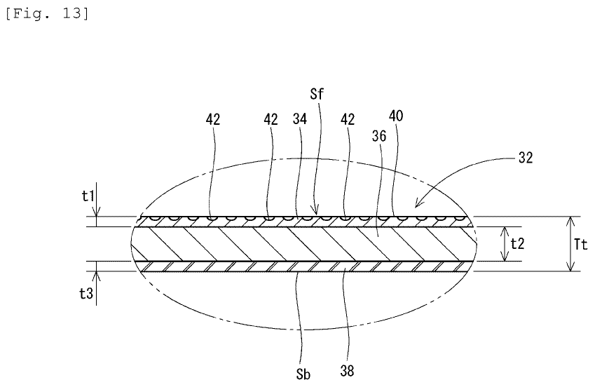

FIG. 13 shows a sheet for a structure 32 according to another embodiment. This sheet 32 has a functional layer 34, an intermediate layer 36 and an adhesive layer 38. The specifications such as material and thickness of the functional layer 34, the intermediate layer 36 and the adhesive layer 38 are the same as the specifications of the functional layer 4, the intermediate layer 6 and the adhesive layer 8 of the sheet for a structure 2 shown in FIGS. 1 to 3. This sheet 32 does not have the reinforcement 10 (refer to FIG. 3). This sheet 32 has a front surface Sf and a back surface Sb.

### [Functional Layer-Exposed Surface]

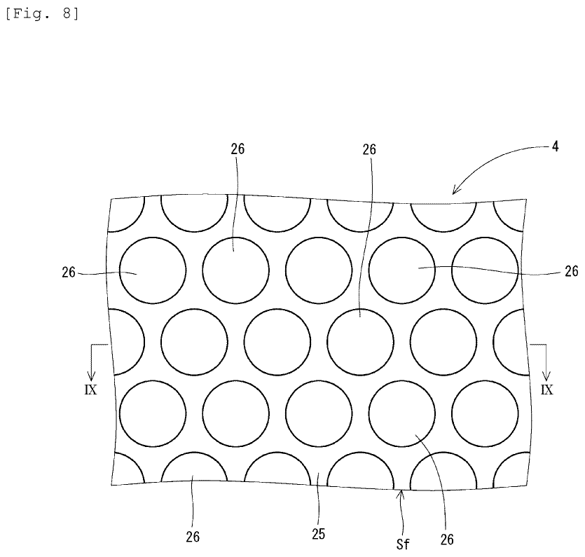

A front surface Sf of this sheet for a structure 32 is a surface on which the functional layer 34 is exposed. This front surface Sf is made up of a land 40 and a plurality of recesses 42. The land 40 and these recesses 42 form the same roughness pattern as that shown in FIG. 7. This sheet 32 has excellent designability. Each of the recesses 42 has the same shape as the shape of the recess 26 shown in FIGS. 8 and 9. This recess 42 is separated from other recesses 42. In a joint that is formed by this sheet 32, water accumulating in the recesses 42 does not proceed to adjacent recesses 42.

This sheet 32 has excellent waterproofness.

### Embodiment 3

The front surface of a sheet for a structure may have a roughness pattern including either or both of minute projections and minute dents. This roughness pattern does not have a land-recess structure. A joint can be formed by overlapping the adhesive layer of a different sheet on this front surface. When the adhesive layer sufficiently conforms to the roughness pattern, a joint where no spaces are present can be obtained. This joint has excellent waterproofness. In the joint, a plurality of spaces separated from one another may be formed. These spaces are less likely to impair the waterproofness. The roughness of the roughness pattern or the fluidity of the adhesive layer is adjusted so that the adhesive layer sufficiently conforms to the roughness pattern.

### EXAMPLES

Hereinafter, the effects of sheets for a structure according to Examples will be clarified. The scope disclosed in the present specification should not be interpreted in a limited manner based on the descriptions of these Examples.

### Example 1

An acrylic silicone resin and a solvent were mixed together to obtain a first paint. The first paint was applied to a release sheet having a roughness pattern on the surface to obtain a first coated film. This first coated film was injected into an oven and held for one hour at a temperature of 80° C. to produce a functional layer. The thickness of this functional layer was 100 μm. On the front surface of the functional layer, a pattern with a shape in which the shape of the roughness pattern of the release sheet was reversed was formed. An enlarged photograph of this pattern is shown in FIG. 14. This pattern has a land and a plurality of recesses. The contour shape of each recess is a circle.

An acrylic emulsion (trade name “SPRING COAT BRUSH MIXTURE” described above) and a cement composition (trade name “SPRING COAT BRUSH POWDER” described above) were mixed together to obtain a second paint. This second paint was applied to the back side of the functional layer to obtain a second coated film. A woven fabric (“KANREISHA #600 CREMONA” from Kuraray Co., Ltd.) was pressed against this second coated film as a reinforcement. This second coated film was heated to obtain an intermediate layer including the reinforcement. The thickness of this intermediate layer was 300 μm.

One hundred parts by mass of an adhesive containing an. acrylic resin (trade name “ORIBAIN BPS 6574” described above) and 6 parts by mass of an isocyanate-based curing agent (trade name “BHS 8515” from TOYOCHEM CO., LTD.) were mixed together to obtain a third paint having a gel fraction of 57%. This third paint was applied onto a release film to obtain a third coated film. This third coated film was heated to obtain an adhesive layer. The thickness of this adhesive layer was 100 μm.

This adhesive layer was overlapped with the intermediate layer. Furthermore, the release sheet was peeled off from the functional layer, and the release film was peeled off from the adhesive layer, thereby obtaining a sheet for a structure of Example 1 having a layer structure shown in FIGS. 1 to 3. The front surface of this sheet had an arithmetic average roughness Ra of 28.9 μm and a maximum depth of 114 μm.

### Example 2

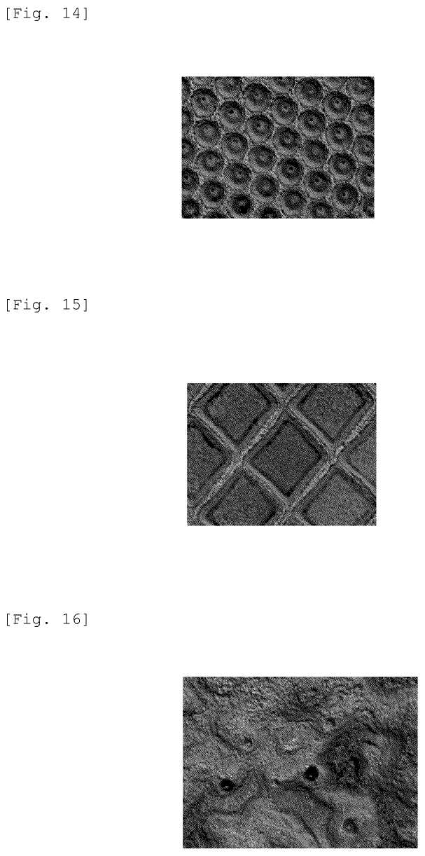

A sheet for a structure of Example 2 was obtained in the same manner as in Example 1 except that the first paint was applied to a release sheet having a different roughness pattern from the roughness pattern of the release sheet in Example 1. The front surface of this sheet had an arithmetic average roughness Ra of 25.6 μm and a maximum depth of 65 μm. An enlarged photograph of the front surface is shown in FIG. 15. This pattern has a land and a plurality of recesses. The contour shape of each recess is a square.

### Comparative Example 1

A sheet for a structure of Comparative Example 1 was obtained in the same manner as in Example 1 except that the first paint was applied to a release sheet having a different roughness pattern from the roughness pattern of the release sheet in Example 1. The front surface of this sheet had an arithmetic average roughness Ra of 30.7 μm and a maximum depth of 127 μm. An enlarged photograph of the front surface is shown in FIG. 16. This sheet has a land-sea pattern. In this pattern, the sea is the matrix.

### [Evaluation of Waterproofness]

Two test pieces were cut out from the sheet for a structure. The size of each test piece was 100 mm×55 mm These test pieces were pasted to a flexible plate so that the width of a joint reached 10 mm. This flexible plate is a plate defined in “JIS A 5430”, and the thickness thereof was 4 mm. These test pieces were subjected to the water permeability test-method B defined in “JIS A 6909:2014”, and the amount of permeating water was measured. These results are shown below.
Example 1: Approximately 0.4 mL
Example 2: Approximately 0.4 mL
Comparative Example 1: More than 5.0 mb

As is clear from these evaluation results, the sheet for a structure of each example was excellent in terms of waterproofness. These evaluation results clarify the superiority of this sheet for a structure.

### [Disclosed Items]

Each of the following items discloses a preferable embodiment.

### [Item 1]

A sheet for a structure including: a functional layer; and an adhesive layer that is positioned on a back side of the functional layer,
in which a front surface of the sheet of a structure includes a land and a plurality of recesses separated from one another.

### [Item 2]

The sheet for a structure according to Item 1, in which an area ratio of the land to the recesses on the front surface is 20/80 or more and 80/20 or less.

### [Item 3]

The sheet for a structure according to Item 1 or 2, in which an average area of the recesses is 0.005 mm² or more and 5.0 mm² or less.

### [Item 4]

The sheet for a structure according to any one of Items 1 to 3, in which an average depth of the recesses is 0.005 mm or more and 0.50 mm or less.

### [Item 5]

The sheet for a structure according to any one of Items 1 to 4, in which an average interval of the recesses is 0.02 mm or more and 1.0 mm or less.

### [Item 6]

The sheet for a structure according to any one of Items 1 to 5, in which a contour shape of each recess is a circle, an ellipse, or a polygon.

### [Item 7]

The sheet for a structure according to any one of Items 1 to 6, further including: an intermediate layer that is positioned between the functional layer and the adhesive layer,
in which a material of the intermediate layer is a composite material containing a polymer and a filler (for example, cement).

### [Item 8]

The sheet for a structure according to any one of Items 1 to 7, further including: a reinforcement that is positioned between the functional layer and the adhesive layer,
in which the reinforcement is a fabric.

### [Item 9]

A repair structure for a structure including:
a structure;
a first sheet pasted to the structure; and
a second sheet having a portion overlapping the first sheet and a remaining portion pasted to the structure,
in which, in a portion where the second sheet overlaps the first sheet, a plurality of spaces are present between the first sheet and the second sheet, and
the plurality of spaces are separated from one another.

### [Item 10]

A repair structure for a structure including:
a structure;
a first sheet pasted to the structure; and
a second sheet having a portion overlapping the first sheet and a remaining portion pasted to the structure,
in which, in a portion where the second sheet overlaps the first sheet, no spaces are present between the first sheet and the second sheet.

### [Item 11]

A method for repairing or reinforcing a structure with a sheet, the method including:
(1) preparing a sheet for a structure that includes a functional layer and an adhesive layer that is positioned on a back side of this functional layer and includes a land and a plurality of recesses separated from one another on a front surface of the sheet for a structure; and
(2) pasting the sheet to a surface of the structure with an adhesive force of the adhesive layer.

### [Item 12]

A method for repairing or reinforcing a structure, the method including:
(1) preparing a first sheet that includes a functional layer and an adhesive layer that is positioned on a back side of the functional layer and includes a land and a plurality of recesses separated from one another on a front surface of the first sheet;
(2) preparing a second sheet that includes a functional layer and an adhesive layer that is positioned on a back side of this functional layer and includes a land and a plurality of recesses separated from one another on a front surface of the second sheet;
(3) pasting the first sheet to a surface of the structure with an adhesive force of the adhesive layer of the first sheet; and
(4) pasting the second sheet to a surface of the first sheet and a surface of the structure with an adhesive force of the adhesive layer of the second sheet while overlapping a part of the second sheet in a vicinity of an edge of the first sheet.

### [Item 13]

A method for re-repairing or re-reinforcing a structure repaired or reinforced with an old sheet, the method including:
(1) preparing a new sheet that includes a functional layer and an adhesive layer that is positioned on a back side of the functional layer and includes a land and a plurality of recesses separated from one another on a front surface of the new sheet; and
(2) pasting the new sheet to a surface of the old sheet that has broken or deteriorated with an adhesive force of the adhesive layer.

### INDUSTRIAL APPLICABILITY

The sheet for a structure described above can be used in a state of being pasted to a variety of objects.

### REFERENCE SIGNS LIST

2 Sheet for structure
2a First sheet
2b Second sheet
4 Functional layer
6 Intermediate layer
8 Adhesive layer
10 Reinforcement
12 Roof
18 Level difference
22 Joint
24 Level difference
25 Land
26 Recess
28 Thread
28a Warp thread
28b Weft thread
30 Mesh
32 Sheet for structure
34 Functional layer
36 Intermediate layer
38 Adhesive layer
40 Land
42 Recess
Sb Back surface
Sf Front surface
Sp Space

1. A sheet for a structure comprising:
a functional layer; and
an adhesive layer that is positioned on a back side of the functional layer, wherein
a front surface of the sheet for a structure includes a land and a plurality of recesses separated from one another.

2. The sheet for a structure according to claim 1, wherein
an area ratio of the land to the recesses on the front surface is 20/80 or more and 80/20 or less.

3. The sheet for a structure according to claim 1, wherein
an average area of the recesses is 0.005 mm² or more and 5.0 mm² or less.

4. The sheet for a structure according to claim 1, wherein
an average depth of the recesses is 0.005 mm or more and 0.50 mm or less.

5. The sheet for a structure according to claim 1, wherein
an average interval of the recesses is 0.02 mm or more and 1.0 mm or less.

6. The sheet for a structure according to claim 1, wherein
a contour shape of each recess is a circle, an ellipse, or a polygon.

7. The sheet for a structure according to claim 1, further comprising:
an intermediate layer that is positioned between the functional layer and the adhesive layer, wherein
a material of the intermediate layer is a composite material containing a polymer and a filler.

8. The sheet for a structure according to claim 1, further comprising:
a reinforcement that is positioned between the functional layer and the adhesive layer, wherein
the reinforcement is a fabric.

9. A repair structure for a structure comprising:
a structure;
a first sheet pasted to the structure; and
a second sheet having a portion overlapping the first sheet and a remaining portion pasted to the structure, wherein
in a portion where the second sheet overlaps the first sheet, a plurality of spaces are present between the first sheet and the second sheet, and
the plurality of spaces are separated from one another.

10. A repair structure for a structure comprising:
a structure;
a first sheet pasted to the structure; and
a second sheet having a portion overlapping the first sheet and a remaining portion pasted to the structure, wherein
in a portion where the second sheet overlaps the first sheet, no spaces are present between the first sheet and the second sheet.

11. A method for repairing or reinforcing a structure with a sheet, the method comprising:
(1) preparing a sheet for a structure that includes a functional layer and an adhesive layer that is positioned on a back side of this functional layer and includes a land and a plurality of recesses separated from one another on a front surface of the sheet for a structure; and
(2) pasting the sheet to a surface of the structure with an adhesive force of the adhesive layer.

12. A method for repairing or reinforcing a structure, the method comprising:
(1) preparing a first sheet that includes a functional layer and an adhesive layer that is positioned on a back side of the functional layer and includes a land and a plurality of recesses separated from one another on a front surface of the first sheet;
(2) preparing a second sheet that includes a functional layer and an adhesive layer that is positioned on a back side of the functional layer and includes a land and a plurality of recesses separated from one another on a front surface of the second sheet;
(3) pasting the first sheet to a surface of the structure with an adhesive force of the adhesive layer of the first sheet; and
(4) pasting the second sheet to a surface of the first sheet and a surface of the structure with an adhesive force of the adhesive layer of the second sheet while overlapping a part of the second sheet in a vicinity of an edge of the first sheet.

13. A method for re-repairing or re-reinforcing a structure repaired or reinforced with an old sheet, the method comprising:
(1) preparing a new sheet that includes a functional layer and an adhesive layer that is positioned on a back side of the functional layer and includes a land and a plurality of recesses separated from one another on a front surface of the new sheet; and
(2) pasting the new sheet to a surface of the old sheet that has broken or deteriorated with an adhesive force of the adhesive layer.

14. The sheet for a structure according to claim 2, wherein
an average area of the recesses is 0.005 mm² or more and 5.0 mm² or less.

15. The sheet for a structure according to claim 2, wherein
an average depth of the recesses is 0.005 mm or more and 0.50 mm or less.

16. The sheet for a structure according to claim 2, wherein
an average interval of the recesses is 0.02 mm or more and 1.0 mm or less.

17. The sheet for a structure according to claim 2, wherein
a contour shape of each recess is a circle, an ellipse, or a polygon.

18. The sheet for a structure according to claim 2, further comprising:
an intermediate layer that is positioned between the functional layer and the adhesive layer, wherein
a material of the intermediate layer is a composite material containing a polymer and a filler.

19. The sheet for a structure according to claim 2, further comprising:
a reinforcement that is positioned between the functional layer and the adhesive layer, wherein
the reinforcement is a fabric.
